(19) United States
(12) Patent Application Publication
(10) Pub. No.: US 2020/0240469 A1
(43) Pub. Date: Jul. 30, 2020

(54) ROLLING BEARING

(71) Applicant: JTEKT CORPORATION, Osaka (JP)

(72) Inventor: Yuki AYAMA, Yao-shi (JP)

(73) Assignee: JTEKT CORPORATION, Osaka (JP)

(21) Appl. No.: 16/748,891

(22) Filed: Jan. 22, 2020

(30) Foreign Application Priority Data
Jan. 30, 2019 (JP) 2019-014131

(51) Int. Cl. F16C 33/58; F16C 19/22

(52) U.S. Cl. CPC F16C 33/58; F16C 19/22

(57) ABSTRACT

A rolling bearing includes an inner ring; an outer ring; rolling elements; and a cage. The cage includes a pair of annular members and cage bars. An inner peripheral surface of at least one of the annular members includes a first inner peripheral surface and a second inner peripheral surface disposed axially inward of the first inner peripheral surface. The first inner peripheral surface is tilted such that an inside diameter of the first inner peripheral surface increases toward an axial inner side. The second inner peripheral surface has a constant inside diameter or is tilted at an angle different from an angle at which the first inner peripheral surface is tilted such that an inside diameter of the second inner peripheral surface increases toward the axial inner side.

### INCORPORATION BY REFERENCE

The disclosure of Japanese Patent Application No. 2019-014131 filed on Jan. 30, 2019 including the specification, drawings and abstract is incorporated herein by reference in its entirety.

### BACKGROUND

### 1. Technical Field

The disclosure relates to a rolling bearing.

### 2. Description of Related Art

Oil-air lubrication, oil mist lubrication, oil jet lubrication, etc. are known as lubrication methods for rolling bearings suitable for high speed rotation. One kind of oil jet lubrication is a method in which oil is supplied into a rolling bearing by injecting oil from an injection port that is open in an outer peripheral surface of a shaft at a position on one side in an axial direction of the rolling bearing. In this kind of oil jet lubrication, it is sometimes difficult to supply oil to an intended position in the rolling bearing because an air curtain is created by high speed rotation of the shaft. Especially, since oil tends to move toward a radial outer side (toward an outer ring) due to a centrifugal force etc., a larger amount of oil is supplied to the outer ring, but it is difficult to supply oil to the inner ring.

Under-race lubrication is known as a lubrication method with improved performance in supplying oil to an inner ring (see, for example, Japanese Unexamined Patent Application Publication No. 2018-150988 (JP 2018-150988 A)). In this under-lace lubrication, oil is directly supplied to an inner ring raceway from an oil passage formed in the inner ring raceway.

### SUMMARY

In under-race lubrication, however, an oil passage is directly formed in the inner ring raceway, which leads to a shortened life of the inner ring raceway, increased production cost, etc.

The disclosure provides a rolling bearing that makes it possible to improve performance in lubricating an inner ring even when an oil passage is not directly formed in the inner ring as in under-race lubrication and a lubrication method is used in which lubricating oil is supplied outward in a radial direction from a position located radially inward of a cage.

An aspect of the disclosure relates to a rolling bearing including an inner ring; an outer ring disposed radially outward of the inner ring so as to face the inner ring; a plurality of rolling elements disposed between the inner ring and the outer ring; and a cage that holds the plurality of rolling elements. The cage includes a pair of annular members disposed at an interval in an axial direction and a plurality of cage bars connecting the pair of annular members, and spaces surrounded by the pair of annular members and the plurality of cage bars are cage pockets that accommodate the rolling elements. An inner peripheral surface of at least one of the annular members includes a first inner peripheral surface and a second inner peripheral surface disposed axially inward of the first inner peripheral surface. The first inner peripheral surface is tilted such that an inside diameter of the first inner peripheral surface increases toward an axial inner side. The second inner peripheral surface has a constant inside diameter or is tilted at an angle different from an angle at which the first inner peripheral surface is tilted such that an inside diameter of the second inner peripheral surface increases toward the axial inner side.

With the rolling bearing having the above configuration, when lubricating oil is supplied outward in the radial direction from a position located radially inward of the cage, the lubricating oil is received and guided inward in the axial direction by the first inner peripheral surface of the at least one of the annular members. The lubricating oil thus easily flows into the cage pockets, facilitating lubrication of contact portions between the inner ring and the rolling elements. Performance in lubricating the inner ring is thus improved. The inner peripheral surface of the at least one of the annular members includes the second inner peripheral surface in addition to the first inner peripheral surface, and the second inner peripheral surface has a constant inside diameter or is tilted at an angle different from an angle at which the first inner peripheral surface is tilted such that the inside diameter of the second inner peripheral surface increases toward the axial inner side. Accordingly, a lubricating oil flow path can be formed in various shapes between the inner peripheral surface of the one annular member and the inner ring. Design flexibility of the flow path is thus enhanced, and the lubricating oil flow can be controlled as desired.

The second inner peripheral surface may be tilted such that the inside diameter of the second inner peripheral surface increases toward the axial inner side; and a tilt angle of the second inner peripheral surface with respect to an axis of the rolling bearing may be larger than a tilt angle of the first inner peripheral surface with respect to the axis. With this configuration, the lubricating oil received and guided toward the axial inner side by the first inner peripheral surface is guided toward the radial outer side by the second inner peripheral surface. The lubricating oil is thus easily caused to flow into the cage pockets.

An outer peripheral surface of the inner ring may have a tilted surface that faces one of the first inner peripheral surface and the second inner peripheral surface, the tilted surface being tilted such that an outside diameter of the tilted surface increases toward the axial inner side. With this configuration, a lubricating oil flow path having a predetermined passage width is formed between the one inner peripheral surface and the outer peripheral surface of the inner ring.

The tilted surface of the inner ring and the one of the first inner peripheral surface and the second inner peripheral surface may be disposed parallel to each other. With this configuration, a lubricating oil flow path having a constant passage width is formed between the one inner peripheral surface and the outer peripheral surface of the inner ring. Accordingly, even when the cage moves in the radial direction or the axial direction, the flow path between the one inner peripheral surface and the tilted surface of the inner ring is maintained, and the lubricating oil is allowed to enter the flow path.

At least the first inner peripheral surface may protrude to a position axially outward of the inner ring. With this configuration, the lubricating oil supplied outward in the radial direction from a position axially outward of the rolling bearing is easily received and guided toward the axial inner side by the first inner peripheral surface.

According to the above aspect of the disclosure, performance in lubricating the inner ring is improved even when an oil passage is not directly formed in the inner ring as in under-race lubrication and a lubrication method is used in which lubricating oil is supplied outward in the radial direction from a position located radially inward of the cage.

### BRIEF DESCRIPTION OF THE DRAWINGS

Features, advantages, and technical and industrial significance of exemplary embodiments of the disclosure will be described below with reference to the accompanying drawings, in which like numerals denote like elements, and wherein:

FIG. 1 shows a vertical section of a rolling bearing according to a first embodiment;

FIG. 2 shows an enlarged vertical section of a main part of the rolling bearing of FIG. 1;

FIG. 3 shows an enlarged vertical section of a main part of a rolling bearing according to a second embodiment;

FIG. 4 shows an enlarged vertical section of a main part of a rolling bearing according to a third embodiment; and

FIG. 5 shows an enlarged vertical section of a main part of a rolling bearing according to a fourth embodiment.

### DETAILED DESCRIPTION OF EMBODIMENTS

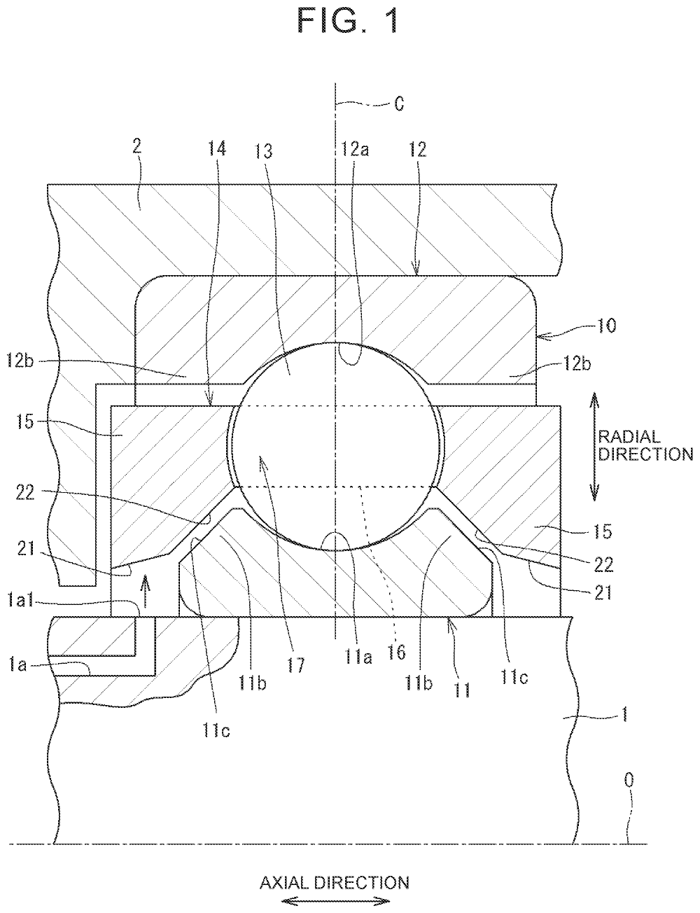

Embodiments of the disclosure will be described below with reference to the accompanying drawings. FIG. 1 shows a vertical section of a rolling bearing according to a first embodiment (a sectional view including an axis of the rolling bearing). A rolling bearing 10 includes an inner ring 11, an outer ring 12, a plurality of rolling elements 13, and a cage 14. The rolling bearing 10 of the present embodiment is a deep groove ball bearing in which the rolling elements 13 are balls. The rolling bearing 10 has a symmetric shape with respect to its axial centerline C.

In the following description, an outer portion in an axial direction of the rolling bearing 10 with respect to an inner portion in the axial direction of the rolling bearing 10 is sometimes referred to as an “axial outer side,” and a direction from the inner portion toward the outer portion in the axial direction of the rolling bearing 10 is sometimes referred to as “axial outward direction” or “outward in the axial direction.” The inner portion in the axial direction of the rolling bearing 10 with respect to the outer portion in the axial direction of the rolling bearing 10 is sometimes referred to as an “axial inner side,” and a direction from the outer portion toward the inner portion in the axial direction of the rolling bearing 10 is sometimes referred to as “axial inward direction” or “inward in the axial direction.”

The inner ring 11 has an annular shape. The outer peripheral surface of the inner ring 11 has a raceway 11a on which the rolling elements 13 roll. The raceway 11a has a substantially concave arc-shaped section. The inner ring 11 includes shoulders 11b respectively provided on both sides of the raceway 11a in the axial direction. An inner peripheral surface of the inner ring 11 is fitted to an outer peripheral surface of a shaft 1 such that the inner ring 11 is fixed to the shaft 1.

The outer ring 12 has an annular shape. The outer ring 12 is disposed radially outward of the inner ring 11. An inner peripheral surface of the outer ring 12 has a raceway 12a on which the rolling elements 13 roll. The raceway 12a has a substantially concave arc-shaped section. The outer ring 12 includes shoulders 12b respectively provided on both sides of the raceway 12a in the axial direction. An outer peripheral surface of the outer ring 12 is fitted to an inner surface of a housing 2 such that the outer ring 12 is fixed to the housing 2. The outer ring 12 of the present embodiment is wider in the axial direction than the inner ring 11. The outer ring 12 thus protrudes toward both sides in the axial direction beyond the inner ring 11 (in other words, the outer ring 12 protrudes to positions axially outward of the inner ring 11).

The rolling elements 13 are disposed at intervals in the circumferential direction between the raceway 11a of the inner ring 11 and the raceway 12a of the outer ring 12. The cage 14 holds the rolling elements 13 and keeps the intervals in the circumferential direction between the rolling elements 13 substantially constant. The cage 14 of the present embodiment is made of a synthetic resin. The cage 14 includes a pair of annular members 15 disposed at an interval in the axial direction and a plurality of cage bars 16 connecting the pair of annular members 15.

The pair of annular members 15 has an annular shape. The plurality of cage bars 16 are disposed at intervals in the circumferential direction. Each space located between the cage bars 16 adjacent to each other in the circumferential direction between the pair of annular members 15 is a cage pocket 17 that accommodates a corresponding one of the rolling elements 13. The cage 14 is wider in the axial direction than the inner ring 11 and the outer ring 12. The cage 14 thus protrudes toward both outer sides in the axial direction beyond the inner ring 11 and the outer ring 12 (in other words, the cage 14 protrudes to positions axially outward of the inner ring 11).

The cage 14 is a fully-encasing cage that holds the rolling elements 13 from both sides in the axial direction. A two-piece cage that is formed by connecting a pair of separate cage members in the axial direction can be used as the cage 14.

Each cage pocket 17 has a circular shape as viewed from the radial outer side. An inner surface of the cage pocket 17 has a concave curved shape conforming to a spherical surface having a radius slightly larger than a radius of an outer peripheral surface of the rolling element 13. Accordingly, there is a small clearance between the cage pocket 17 and the outer peripheral surface of the rolling element 13. The cage 14 is positioned by the rolling elements 13. In other words, the cage 14 is guided by the rolling elements 13.

The inner ring 11 of the rolling bearing 10 rotates with rotation of the shaft 1. At this time, the rolling elements 13 revolve around the axis of the rolling bearing 10 while rolling on the raceway 11a of the inner ring 11 and the raceway 12a of the outer ring 12. The cage 14 holding the rolling elements 13 also rotates about the axis of the rolling bearing 10 with the revolution of the rolling elements 13.

The rolling bearing 10 of the present embodiment is lubricated by oil jet lubrication. The shaft 1, on which the inner ring 11 is fitted, has an oil passage 1a through which lubricating oil flows. The oil passage 1a has an oil supply port 1a1 provided at the axial outer side of the rolling bearing 10. The oil supply port 1a1 is open at the outer peripheral surface of the shaft 1. Lubricating oil flows through the oil passage 1a and is injected outward in the radial direction from the oil supply port 1a1. Since the shaft 1 is rotating, a centrifugal force in the radial outward direction is applied to the lubricating oil injected from the oil supply port 1a1.

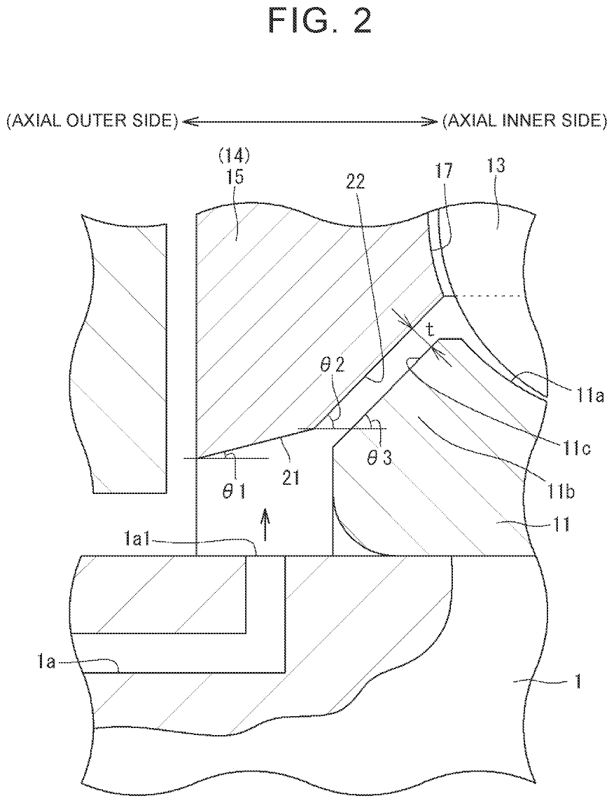

The annular member 15 on one side (the left side in FIG. 1) of the cage 14 in the axial direction is disposed radially outward of the oil supply port 1a1. FIG. 2 shows an enlarged vertical section of a main part of the rolling bearing 10 of FIG. 1. An inner peripheral surface of the annular member 15 includes a first inner peripheral surface 21 and a second inner peripheral surface 22. The first inner peripheral surface 21 is tilted such that the inside diameter of the first inner peripheral surface 21 gradually increases toward the axial inner side. The second inner peripheral surface 22 is also tilted such that the inside diameter of the second inner peripheral surface 22 gradually increases toward the axial inner side. An angle (minor angle) θ1 of the first inner peripheral surface 21 with respect to an axis O (see FIG. 1) of the rolling bearing 10 and the angle (minor angle) θ2 of the second inner peripheral surface 22 with respect to the axis O of the rolling bearing 10 are different from each other.

In the present embodiment, the angle θ1 of the first inner peripheral surface 21 is set to 0°<θ1<90°, and the angle θ2 of the second inner peripheral surface 22 is set to 0°<θ2<90°. These angles θ1, θ2 satisfy θ1<θ2.

The first inner peripheral surface 21 protrudes to a position axially outward of the inner ring 11. The first inner peripheral surface 21 is disposed radially outward of the oil supply port 1a1 of the oil passage 1a. The entire oil supply port 1a1 is thus covered by the first inner peripheral surface 21 from the radial outer side. An axial outer part of the second inner peripheral surface 22 protrudes to a position axially outward of the inner ring 11.

The outer peripheral surface of the shoulder 11b of the inner ring 11 has a tilted surface 11c. The tilted surface 11c is tilted such that the outside diameter gradually increases toward the axial inner side. An angle (minor angle) θ3 of the tilted surface 11c with respect to the axis O of the rolling bearing 10 is set to 0°<θ3<90°. In the present embodiment, the angle θ2 of the second inner peripheral surface 22 and the angle θ3 of the tilted surface 11c satisfy θ2=θ3. That is, the second inner peripheral surface 22 and the tilted surface 11c are parallel to each other.

Lubricating oil injected from the oil supply port 1a1 of the oil passage 1a is sprayed onto the first inner peripheral surface 21 disposed radially outward of the oil supply port 1a1. The lubricating oil thus sprayed onto the first inner peripheral surface 21 flows on the first inner peripheral surface 21 due to the centrifugal force generated by rotation of the cage 14. Specifically, since the first inner peripheral surface 21 is tilted such that the inside diameter gradually increases toward the axial inner side, the lubricating oil is guided toward the axial inner side on the first inner peripheral surface 21 and flows into the clearance between the second inner peripheral surface 22 and the inner ring 11.

The lubricating oil having flowed into the clearance between the second inner peripheral surface 22 and the inner ring 11 is further guided toward the axial inner side by the second inner peripheral surface 22. Since the second inner peripheral surface 22 is tilted at the angle θ2 larger than the angle θ1 of the first inner peripheral surface 21, the lubricating oil is guided further toward the radial outer side. The lubricating oil therefore easily flows into the cage pockets 17, facilitating lubrication of the rolling elements 13 in the cage pockets 17 and the raceway 11a of the inner ring 11 contacted by the rolling elements 13. Performance in lubricating the inner ring 11 is thus improved.

The outer peripheral surface of the shoulder 11b of the inner ring 11 has the tilted surface 11c parallel to the second inner peripheral surface 22. Accordingly, a lubricating oil flow path formed between the second inner peripheral surface 22 and the tilted surface 11c has a uniform width t along the entire length of the flow path. Even when the cage 14 slightly moves in the radial direction and the axial direction while being guided by the rolling elements 13, the width t of the lubricating oil flow path between the second inner peripheral surface 22 and the tilted surface 11c of the inner ring 11 is kept uniform, and the lubricating oil flow path does not narrow locally (in other words, there is no local narrow portion in the lubricating oil flow path). The lubricating oil flow in the flow path is therefore hardly disrupted.

Since the first inner peripheral surface 21 covers the entire oil supply port 1a1 from the radial outer side, lubricating oil injected from the oil supply port 1a1 is reliably received and guided toward the axial inner side by the first inner peripheral surface 21.

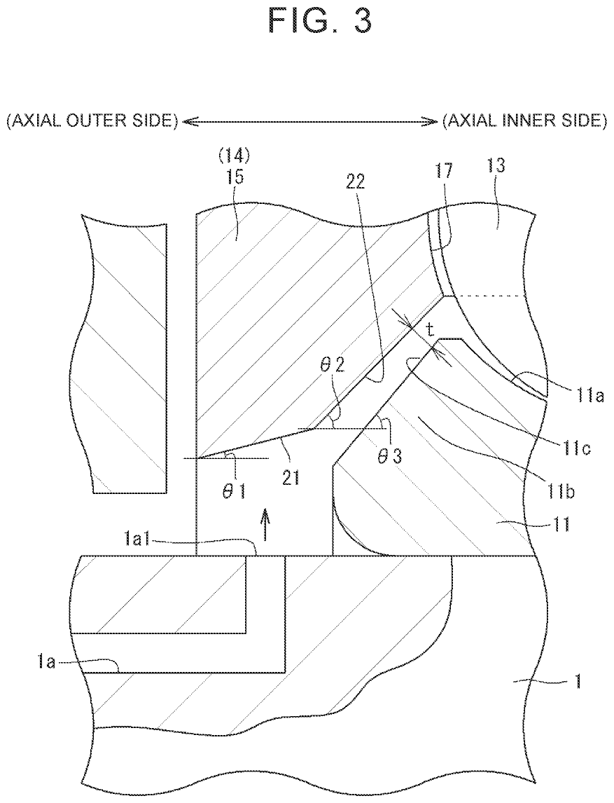

FIG. 3 shows an enlarged vertical section of a main part of a rolling bearing according to a second embodiment. In the present embodiment, the angle θ2 of the second inner peripheral surface 22 and the angle θ3 of the tilted surface 11c of the inner ring 11 are not the same and satisfy θ2<θ3. The width t of the lubricating oil flow path formed between the second inner peripheral surface 22 and the tilted surface 11c of the inner ring 11 is non-uniform along the entire length of the flow path, and is wider on the axial outer side and narrower on the axial inner side. Lubricating oil guided from the first inner peripheral surface 21 toward the axial inner side therefore easily flows into the flow path between the second inner peripheral surface 22 and the tilted surface 11c. The lubricating oil is thus more easily caused to flow into the cage pockets 17.

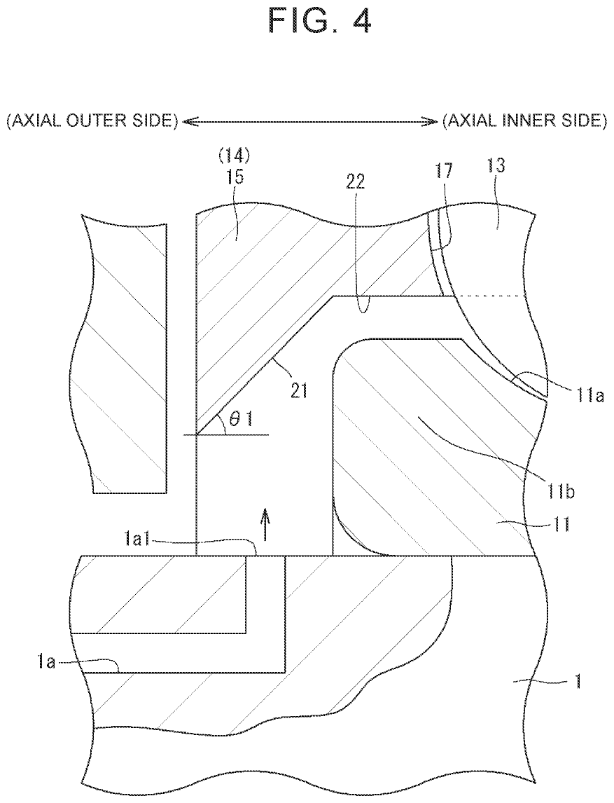

FIG. 4 shows an enlarged vertical section of a main part of a rolling bearing according to a third embodiment. In the present embodiment, the second inner peripheral surface 22 is parallel to the axis O of the rolling bearing 10, and the outer peripheral surface of the shoulder 11b of the inner ring 11 is also parallel to the axis O of the rolling bearing 10. That is, the angles corresponding to θ2 and θ3 in FIGS. 2 and 3 is 0°. The second inner peripheral surface 22 and the outer peripheral surface of the shoulder 11b of the inner ring 11 are therefore parallel to each other.

In the present embodiment, lubricating oil guided toward the axial inner side by the first inner peripheral surface 21 flows into the clearance between the second inner peripheral surface 22 and the inner ring 11. Since the second inner peripheral surface 22 is parallel to the axis O, the lubricating oil is restrained from flowing inward in the axial direction and outward in the radial direction. That is, the lubricating oil flow facilitated by the first inner peripheral surface 21 is limited by the second inner peripheral surface 22. In the first and second embodiments, lubricating oil is guided inward in the axial direction and outward in the radial direction by the second inner peripheral surface 22. In the present embodiment, in contrast, lubricating oil is restrained from flowing inward in the axial direction and outward in the radial direction. That is, the second inner peripheral surface 22 appropriately controls the lubricating oil flow to the cage pockets 17 and the rolling elements 13 by its angle θ2, and adjusts the amount of lubricating oil flowing into the cage pockets 17 as desired.

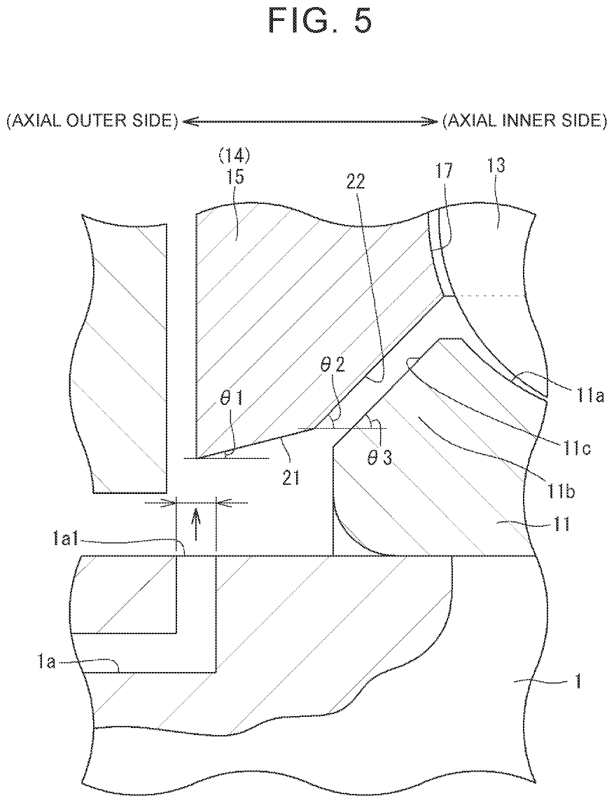

FIG. 5 shows an enlarged vertical section of a main part of a rolling bearing according to a fourth embodiment. In the present embodiment, the first inner peripheral surface 21 of the annular member 15 covers a part of the oil supply port 1a1 of the oil passage 1a from the radial outer side instead of covering the entire oil supply port 1a1 of the oil passage 1a from the radial outer side. With this configuration as well, lubricating oil injected from the oil supply port 1a1 is guided toward the axial inner side by the first inner peripheral surface 21. Supply of the lubricating oil to the cage pockets 17 and the rolling elements 13 is thus facilitated.

The first inner peripheral surface 21 of the annular member 15 may not cover the oil supply port 1a1 of the oil passage 1a and may be disposed closer to the axial inner side than the oil supply port 1a1 is (i.e., may be disposed axially inward of the oil supply port 1a1). In this case, the first inner peripheral surface 21 does not serve to guide lubricating oil injected from the oil supply port 1a1 toward the axial inner side as much as the first inner peripheral surface 21 does in the other embodiments. However, the first inner peripheral surface 21 guides, toward the axial inner side, the lubricating oil that has spread in the axial direction and flowed into a region located radially inward of the first inner peripheral surface 21.

The disclosure is not limited to the above embodiments and their design may be changed within the scope of the disclosure. In the above embodiments, the inner peripheral surface of the annular member 15 includes two inner peripheral surfaces, namely the first inner peripheral surface 21 and the second inner peripheral surface 22. However, the inner peripheral surface of the annular member 15 may include three or more inner peripheral surfaces. For example, the inner peripheral surface of the annular member 15 may include a third inner peripheral surface that is located axially outward of the first inner peripheral surface 21, between the first inner peripheral surface 21 and the second inner peripheral surface 22, or axially inward of the second inner peripheral surface 22. When the inner peripheral surface of the annular member 15 includes three or more inner peripheral surfaces, it is not necessary that all of the inner peripheral surfaces should have different tilt angles, and it is necessary that the inner peripheral surfaces located adjacent to each other in the axial direction should have different tilt angles and the tilt angles should be larger than 0° and smaller than 90°.

In the above embodiments, the oil passage 1a and the oil supply port 1a1 are formed in the shaft 1. However, the oil passage 1a and the oil supply port 1a1 may be formed in a spacer or the like disposed adjacent to the inner ring 11 or the outer ring 12. In the above embodiments, the oil supply port 1a1 is open in the radial outward direction perpendicular to the axis O. However, the disclosure is not limited to this configuration. The direction in which lubricating oil is injected preferably includes a component in the radial outward direction, and the oil supply port 1a1 may be open such that lubricating oil is injected in, e.g., a direction tilted with respect to the radial outward direction.

In the above embodiments, the cage 14 protrudes toward the axial outer side beyond the inner ring 11 (in other words, the case 14 protrudes to positions axially outward of the inner ring 11). However, the cage 14 may be disposed within the width of the inner ring 11. With this configuration as well, lubricating oil injected from the oil supply port 1a1 spreads in the axial direction and thus enters between the cage 14 and the inner ring 11, and is guided inward in the axial direction by the first inner peripheral surface 21.

Since the cage 14 has a symmetric shape with respect to the axial centerline C of the rolling bearing 10, each of the annular members 15 has the first inner peripheral surface 21 and the second inner peripheral surface 22. However, only the annular member 15 located on the one side in the axial direction, namely on the side on which the oil passage 1a is formed, may have the first inner peripheral surface 21 and the second inner peripheral surface 22.

The oil passages 1a may be respectively formed on both axial outer sides of the rolling bearing 10. In this case, lubricating oil injected from the oil supply ports 1a1 of the oil passages 1a is guided toward the axial inner side by the first inner peripheral surfaces 21 of the annular members 15 on both sides in the axial direction. The angle θ1 of the first inner peripheral surface 21 and the angle θ2 of the second inner peripheral surface 22 may satisfy θ1>θ2.

The method for lubricating the rolling bearing 10 is not limited to oil jet lubrication, and any other lubrication method may be used as long as lubricating oil is supplied to the rolling bearing 10 from the axial outer side of the rolling bearing 10. The rolling bearing 10 is not limited to the deep groove ball bearing and may be an angular contact ball bearing, a cylindrical roller bearing, a tapered roller bearing, etc.

What is claimed is:

1. A rolling bearing comprising:
an inner ring;
an outer ring disposed radially outward of the inner ring so as to face the inner ring;
a plurality of rolling elements disposed between the inner ring and the outer ring; and
a cage that holds the plurality of rolling elements, wherein:
the cage includes a pair of annular members disposed at an interval in an axial direction and a plurality of cage bars connecting the pair of annular members, and spaces surrounded by the pair of annular members and the plurality of cage bars are cage pockets that accommodate the rolling elements;
an inner peripheral surface of at least one of the annular members includes a first inner peripheral surface and a second inner peripheral surface disposed axially inward of the first inner peripheral surface;
the first inner peripheral surface is tilted such that an inside diameter of the first inner peripheral surface increases toward an axial inner side; and
the second inner peripheral surface has a constant inside diameter or is tilted at an angle different from an angle at which the first inner peripheral surface is tilted such that an inside diameter of the second inner peripheral surface increases toward the axial inner side.

2. The rolling bearing according to claim 1, wherein:
the second inner peripheral surface is tilted such that the inside diameter of the second inner peripheral surface increases toward the axial inner side; and
a tilt angle of the second inner peripheral surface with respect to an axis of the rolling bearing is larger than a tilt angle of the first inner peripheral surface with respect to the axis.

3. The rolling bearing according to claim 1, wherein an outer peripheral surface of the inner ring has a tilted surface that faces one of the first inner peripheral surface and the second inner peripheral surface, the tilted surface being tilted such that an outside diameter of the tilted surface increases toward the axial inner side.

4. The rolling bearing according to claim 3, wherein the tilted surface of the inner ring and the one of the first inner peripheral surface and the second inner peripheral surface are disposed parallel to each other.

5. The rolling bearing according to claim 1, wherein at least the first inner peripheral surface protrudes to a position axially outward of the inner ring.
